(19) United States
(12) Patent Application Publication
(10) Pub. No.: US 2009/0232242 A1
(43) Pub. Date: Sep. 17, 2009

(54) Nested Turbo Code Design for the Costa Problem

(76) Inventors: Zixiang Xiong, Spring, TX (US); Yong Sun, Sugar Land, TX (US); Momin Uppal, College Station, TX (US); Angelos Liveris, Sugarland, TX (US); Szeming Cheng, Tulsa, OK (US); Vladimir Stankovic, Glasgow (GB)

Correspondence Address: Tod T. Tumey, P.O. BOX 22188, HOUSTON, TX, 77227-2188, US

(21) Appl. No.: 12/241,004

(22) Filed: Sep. 29, 2008

Related U.S. Application Data
(60) Provisional application No. 60/976,073, filed on Sep. 28, 2007.

(51) Int. Cl. H04L 5/12

(52) U.S. Cl. 375/265; 714/792

(57) ABSTRACT

A method for the Costa problem includes turbo-like nested code. In one embodiment, the method includes providing a turbo-like trellis-coded quantization for source coding. The method also includes providing a turbo trellis-coded modulation for channel coding.

### CROSS-REFERENCE TO RELATED APPLICATIONS

This application is a non-provisional application that claims the benefit of U.S. Application Ser. No. 60/976,073 filed on Sep. 28, 2007, which is incorporated by reference herein in its entirety.

STATEMENT REGARDING FEDERALLY SPONSORED RESEARCH OR DEVELOPMENT

Not applicable.

### BACKGROUND OF THE INVENTION

1. Field of the Invention

This invention relates to the field of source-channel coding and more specifically to the field of nested turbo codes for the Costa problem.

2. Background of the Invention

Channel coding with side information (CCSI) refers to the problem of communicating over a noisy channel with partial knowledge about the transmission channel in the form of side information that is available at the encoder but not at the decoder. In the multi-media data hiding or watermarking problem, a message (or watermark) is typically to be embedded into a multi-media host signal (i.e., audio, image or video host signal). The host signal is present only at the encoder as the side information. Conventional rules of data embedding include that the host medium is minimally perturbed (i.e., the embedding processing is minimally intrusive) and that the embedded message may be reliably recovered by the intended decoder including when in the presence of an attacker that may attempt to corrupt or erase the message while not rendering the embedded host signal unusable. The Costa problem involves an assumption that the side information is non-causally available at the encoder.

Although CCSI by association may be related to covert communication problems such as data hiding, the scope of its applicability may extend to non covert communication systems. For instance, the most efficient way to digitally broadcast may be to follow the principle of CCSI. Other applications of CCSI include pre-coding for inter-symbol interference channels and transmitter cooperation in wireless networks.

In regards to such applications, Costa code designs have been developed. For instance, a design includes Costa coding for information embedding based on the simplest scalar quantization. Drawbacks include achieving a gap of 3.5 dB from the capacity at 1.0 bit per sample (b/s). Another design includes employing trellis-coded quantization (TCQ) as the source code and trellis-coded modulation (TCM) as the channel code. Drawbacks include the TCQ/TCM scheme operating 3.75 dB, 5.75 dB, and 6.0 dB away from the capacity at 2.0 b/s, 1.0 b/s, and 0.5 b/s, respectively, which may be attributed to the weakness of TCM.

Further designs include a turbo-coded trellis-based Costa coding scheme by nesting a TCQ source code inside a turbo TCM (TTCM) channel code. Drawbacks Include the actual performance of TCQ severely degraded when it is couple (or nested) with TTXM, for instance at a low rate. Such drawbacks may be related to the structural dissimilarity between TCQ and TTCM. For instance, at 1.0 b/s, the scheme may perform 2.07 dB away from the capacity.

Some designs have targeted the low rate regime. For instance, a design has been developed that includes an efficient code design within the framework of nested lattice codes that may perform 1.3 dB from the capacity at 0.25 b/s by using vector quantization (VQ) and irregular repeat-accumulate (IRA) codes. Another design scheme has been devise based on superposition coding, which may achieve the same performance as TCQ and low-density parity-check (LDPC) codes. Additional design schemes include using a combined source-channel coding approach that may provide a result of 0.83 dB away form the capacity at 0.25 b/s by using TCQ and IRA codes. Drawbacks to such design schemes include that such schemes may not be straightforwardly applied to the high rate regime because it may be more involved to design sufficient high rate LDPC/IRA codes for multi-level constellations, for instance when shaping is used.

Consequently, there is a need for a system that sufficiently performs at both low and high transmission rates. Further needs include an improved scheme for the Costa problem.

### BRIEF SUMMARY OF SOME OF THE PREFERRED EMBODIMENTS

These and other needs in the art are addressed in one embodiment by a method for the Costa problem includes turbo-like nested code. The method includes providing a turbo-like trellis-coded quantization for source coding. The method also includes providing a turbo trellis-coded modulation for channel coding.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will be made to the accompanying drawings in which:

FIG. 1 illustrates a CCSI at the encoder;

FIG. 2(a) illustrates a binning scheme for a 1-D nested lattice/scalar code;

FIG. 2(b) illustrates encoding for a 1-D nested lattice/scalar code;

FIG. 2(c) illustrates decoding for a 1-D nested lattice/scalar code;

FIG. 3 illustrates Equation (4) for defining Loss_{SC} due to source coding;

FIG. 4 illustrates source coding loss Loss_{SC} (in dB) in practical Costa coding at three different rates;

FIG. (5a) illustrates the upper bound on the granular gain of lattice quantization of Gaussian sources;

FIG. 5(b) illustrates the upper bound on the packing gain of lattice channel codes for AWGN channels;

FIG. 6 illustrates a block diagram of a TCQ/TTCM encoder;

FIG. 7 illustrates a block diagram of a turbo-like TCQ/TTCM encoder;

FIG. 8 illustrates Equation (6) for I_{S};

FIG. 9 illustrates a matrix form of I_{S};

FIG. 10 illustrates Equation (7) for a distortion metric p₁(t);

FIG. 11 illustrates Equation (8) for p₂;

FIG. 12 illustrates Equation (9) for determining I_{S};

FIG. 13 illustrates Equation (10) for hard threshing I_{S} to I;

FIG. 14 illustrates a performance gap of a turbo-like TCQ/TCM code;

FIG. 15 illustrates a performance gap of a turbo-like TCQ/TCM code;

FIG. 16 illustrates a performance gap of a turbo-like TCQ/TCM code;

FIG. 17 illustrates Table I showing a performance gap to the capacity-achieving SNR for different code designs;

FIG. 18 illustrates Table II showing a performance gap to the capacity-achieving SNR for different code designs; and

FIG. 19 illustrates Table III showing a performance gap to the capacity-achieving SNR for different code designs.

### DETAILED DESCRIPTION OF THE PREFERRED EMBODIMENTS

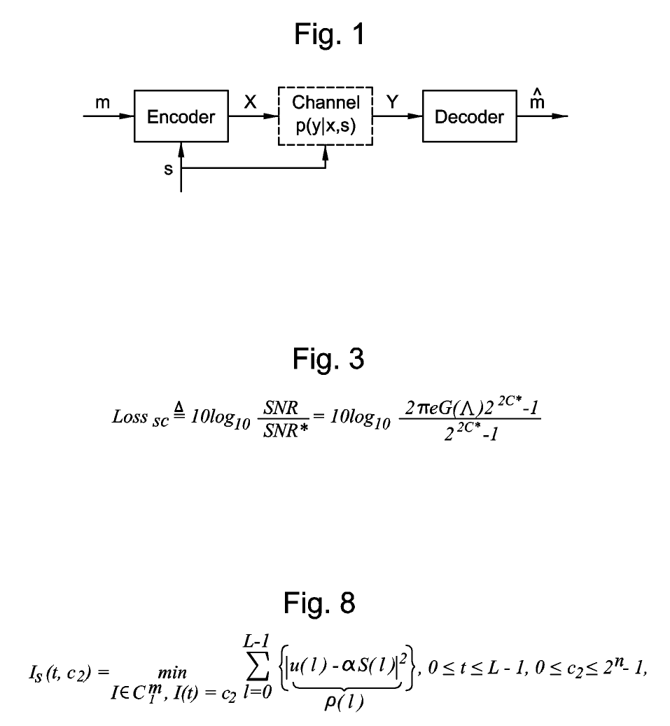

FIG. 1 illustrates a CCSI at the encoder (i.e., Gelfand-Pinsker coding). The transmitter (not illustrated) desires to send message m ε {1, . . . , M} over a memory less channel, which is defined by the transition probabilities p(y\x,s). The references “x” and “y” are the channel input and output, respectively. The random variable “s,” which is independent of “x,” is the state of the channel (i.e., the side information), which is know causally to the transmitter but not to the receiver. Based on the selected message “m” and the state of the channel “s,” the encoder sends codeword x, which must satisfy the power constraint E[X²]≦P_{X}. The capacity is provided by Equation (1) as follows:

$${C}^{*} = {max}_{P ( u , x \backslash s )} [ I ( U ; Y ) - I ( U ; S ) ] ,$$

where U is an auxiliary random variable such that Y→(X,S)→U and Y→(U,S)→X form Markov chains and E[X²]≦P_{X}. The proof of the Gelfand-Pinsker capacity is based on random coding and binning.

It is to be understood that Gelfand-Pinsker coding in general suffers performance loss when compared to channel coding with side information available at both the transmitter and the receiver. For instance, in a binary Gelfand-Pinsker problem, the channel output is Y=X+S+Z, where X, S, and Z are channel input, a binary-symmetric signal known to the transmitter but not to the receiver, and unknown i.i.d. Bernoulli-p channel noise, respectively. Under a Hamming power constraint 1/n*E[w_{H}(X)]≦δ, 0<δ<½, the capacity is given by C*+u.c.e.{H(δ)−H(p), (0, 0)}, where u.c.e. means upper concave envelope. C* is strictly smaller than the capacity C=H(p*δ)−H(p) when the decoder also has access to the side information S.

In contrast to the binary case of Gelfand-Pinsker coding, in the Guassian case, there is no performance loss with CCSI when having the Costa problem. For instance, when S and Z are i.i.d. zero-mean Gaussian and the average channel input power constrain is E[X²]≦P_{X}. Costa showed that the capacity is given by Equation (2) as follows

C*=½ log(1+P_{X}/P_{Y}),

where P_{Z} is the noise power. Therefore, although S is unknown to the decoder, the capacity remains the same as if S were available at the decoder. Costa's proof is again based on random coding and binning. The result of Equation (2) has been extended to arbitrarily distributed interference S.

Although Costa's proof shows the existence of capacity-achieving random binning schemes, the proof does not provide an indication about practical code construction. An algebraic binning scheme based on nested lattice codes has been suggested. The scheme includes a coarse lattice code nested within a fine lattice code. The fine lattice code may need to be a good channel code, and the coarse lattice code may need to be a good source code to approach the capacity in Equation (2).

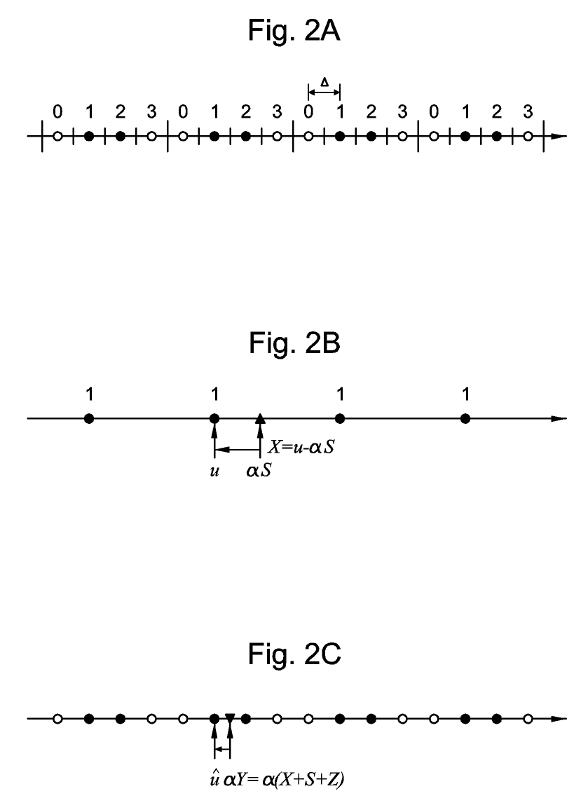

FIG. 2(a) illustrates 1-D nested lattice/scalar codes with an infinite uniform constellation, where Δ denotes the step size. The channel code words are grouped into cosets/bins (labeled as 0, 1, 2, and 3) for source coding. At the encoder, the side information S is linearly scaled by α and quantized to the closest code word “u” by the source code selected by the message “m” to be transmitted (i.e., the coset/bin labeled 1 in FIG. 2(b)) so that the obtained quantization error X=u−αS satisfies the power constraint E[X²]≦P_{X}. X is transmitted over the additive white Gaussian noise channel with noise Z˜N(0, P_{Z}). In an embodiment, the optimal α=P_{X}/(P_{X}+P_{Z})=SNR/(SNR+1), with SNR=P_{X}/P_{Z}. As shown in FIG. 2(c), the decoder receives the signal Y=X+S+Z, scales it by α, and finds the codeword û closest to αY. The index of the bin containing û is identified as the decoded message.

It has been shown that this nested scheme approaches the capacity in Equation (2) as the dimensionality of the employed lattices approaches infinity. However, nested lattice coding calls for a joint source-channel code design, which may have the same dimensional coarse lattice source code and fine lattice channel code and that which may be difficult to implement in high dimensions.

In an embodiment, a scheme includes an algebraic message-based binning interpretation of Costa coding in terms of source-channel coding. In some embodiments, the interpretation is used as the guiding principle for code designs. Without limitation, form an information-theoretical perspective, there are granular gain and boundary gain in source coding, packing gain and shaping gain in channel coding. Dirty-paper coding is primarily a channel coding problem (for transmitting messages). Dirty-paper writing was disclosed in “Writing on Dirty Paper,” M. Costa, IEEE Trans. Inform. Theory, vol. 29, pp. 439-441, May 1983, which is incorporated by reference in its entirety. The packing gain and the shaping gain may be considered. In addition, in light of the side information, source coding is involved to satisfy the power constraint. Therefore, the constellation may be infinitely replicated so that the side information may be quantized to satisfy the power constraint. Therefore, the source code in Costa coding is not conventional in that there is only granular gain but no boundary gain. It is to be understood that the equivalence between the shaping in channel coding and the granular gain in source coding (i.e., via nested lattice codes) may be establishes for Costa coding. Consequently, the shaping gain via source coding and the packing gain via channel coding may be sought. In an embodiment, the equivalence may be accomplished with quantizers (e.g., TCQ) having almost spherical Voronoi regions in a high-dimensional Euclidean space, and the gains via the source codings, respectively, with near-capacity channel codes (i.e., turbo and LDPC codes).

In embodiments, a nested approach based on TCQ and TTCM for message-based algebraic binning includes channel code words are grouped corresponding to the same message into a bin, and, within each bin, the code word is chosen according to the side information. The code word is adapted to the side information.

In an embodiment, when the dimension of the coarse lattice Λ for source coding (or quantization) is finite but high, it has been shown that the capacity of the modulo lattice channel induced by the lattice quantizer Λ is lower bounded by Equation (3) as follows.

C=½ log₂(1+SNR)−½ log₂*2πeG(ζ),

Where G(Λ) is the normalized second moment of Λ. Since G(Λ) starts from 1/12 in the one dimensional case and symptocially approaches 1/(2πe) when the dimensionality of Λ goes to infinity. The granular gain g(Λ)=−10 log₁₀12G(Λ) of Λ is maximally 1.53 dB. Equation (3) indicates that with ideal channel coding, the loss in rate due to high-dimensional lattice quantization is maximally ½ log₂*2πeG(Λ) b/s. With practical channel coding, there is an additional packing loss “Loss_{CC}” (in dB). In order to measure the losses form both source coding and channel coding (in dB), the lower bound C in Equation (3) has been equated with C*=½ log₂(1+SNR*) and define Loss_{CC} (in dB) due to source coding as Equation (4) as shown in FIG. 3, where SNR*=2^{2C*}−1 is the capacity-achieving SNR. The total performance loss is computer (in dB) in practical Costa coding as Equation (5) as follows.

Loss_{Total}=Loss_{SC}+Loss_{CC}

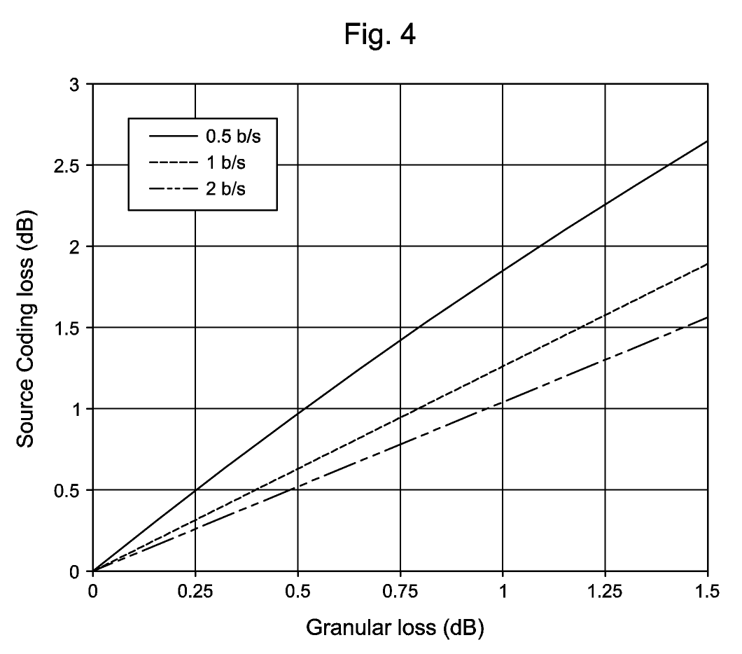

In an embodiment in which the capacity C* is high, Loss_{SC}=10 log₁₀2πeG(Λ)=1.53-g(Λ) db. For instance, Loss_{SC} approximately equal to the granular loss from source coding in this case. But, as shown in FIG. 4 that as C* decreases, the granular loss is increasingly magnified to become Loss_{SC}. In embodiments, to reduce Loss_{SC}, a high-dimensional lattice quantizer (or VQ in general) is used to reduce the granular loss, which may automatically preclude the scalar Costa scheme from approaching the capacity.

As shown in Equation (5), it can be seen that a result of the Costa code design is to employ both a strong source and channel codes so that total loss is minimized. Once the source and channel codes are chosen, the expected performance of the resulting Costa code may be obtained. In addition, once the performance of a Costa code is known, Loss_{SC} due to source coding may be separately measured from Equation (4) in which G(Λ) is replaced by the normalized version of the mean square error (MSE) E[X²] introduced by the quantizer and the packing loss Loss_{CC} due to channel coding. It is to be understood that such are guidelines to be followed in constructing practical Costa codes.

According to Equation (5), a nested lattice code may asymptotically approach the capacity of Costa coding in Equation (2) when the dimensionality of the employed lattices (for source coding and channel coding) goes to infinity. Nested linear lattice codes are disclosed in the article “Nested linear/lattice codes for structured Multiterminal binning,” R. Zmir, S. Shamai, and U. Erez, IEEE Trans. Inform. Theory, vol. 48, pp. 1250-1276, June 2002, which is incorporated by reference in its entirety. However, whereas recent progress in iterative decoding of graph-based (e.g., LDPC) codes has made it possible to implement equivalent lattice channel codes of very high effective dimensions (e.g., in the thousands), such progress has not yet been mirrored in practical source coding. For instance, turbot TCQ may be worse than TCQ, which may be conventionally the most efficient practical scheme for quantization. As an example, a 256-state TCQ with 1.32 dB granular gain may only outperform lattice source codes of up to 69 dimensions. Without limitation, the lack of practically efficient graph-based codes for quantization of continuous (e.g., Gaussian) sources in general (and turbo TCQ in particular) provides difficulties In implementing nested codes with the same but very high effective dimensionality.

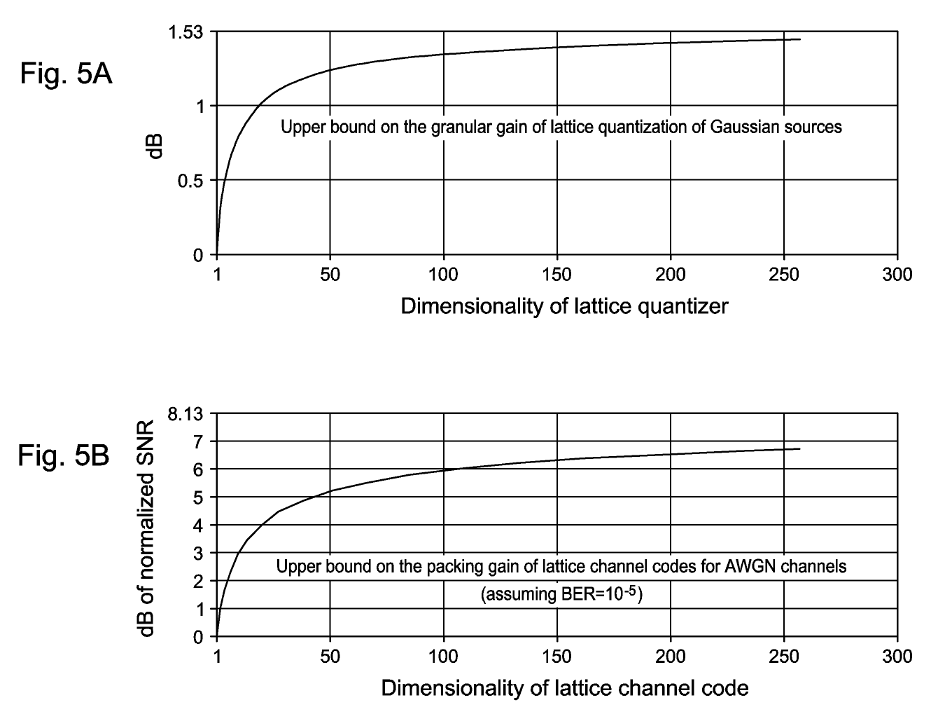

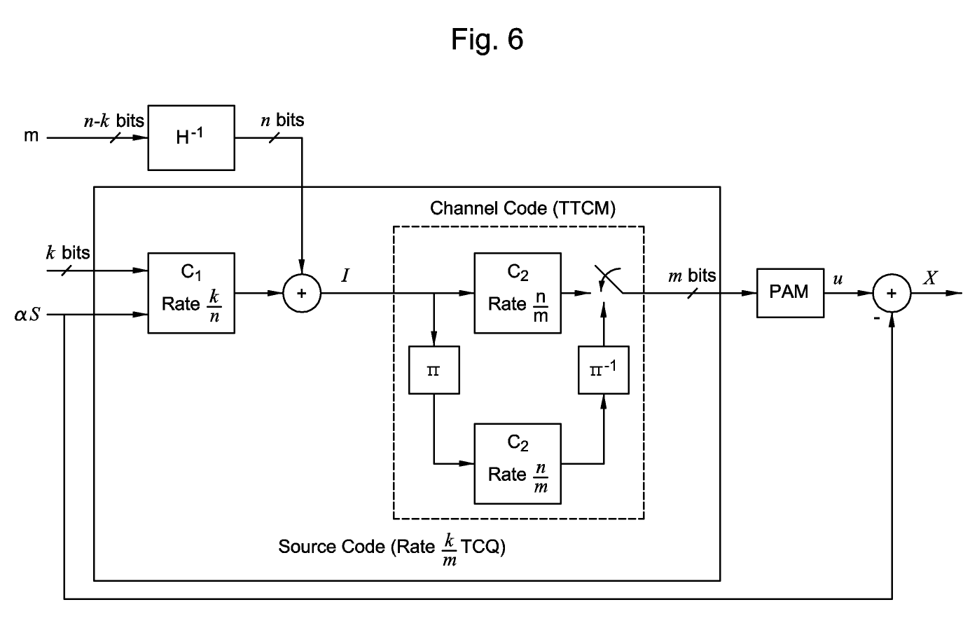

To further Illustrate the performance difference between lattice codes for source and channel coding, the upper bound on the granular gain (in dB) of lattice quantization of Gaussian sources and the upper bound on the packing gain (in normalized SNR) of lattice channel codes for AWGN channels (assuming BER=10⁻⁵) are plotted in FIG. 5 as the functions of lattice dimensionality. With nested scalar lattices for Costa coding, the fine source code (uniform scalar quantization) leaves unexploited the maximum granular gain of only 1.53 dB. The coarse channel code (scalar coset code) gives up the maximum 8.13 dB packing gain. With nested trellis-based codes, the effective dimensionality of TCQ or TCM may be less than 300 in practice. The upper bounds in FIGS. 5 and 6 may be used to predict and explain the performance of TCQ/TCM code constructions. In addition, FIG. 5 provides a one-to-one correspondence between the granular/packing gain of any source/channel code and the effective dimensionality of its equivalent lattice code. It may be seen that the granular loss of lattice quantization at dimension 256 is less than 0.1 dB, but lattice channel codes at this dimension may suffer more than 1 dB packing loss. Without limitation, the effective dimensionality of capacity-approaching turbo or LDPC codes may be much higher than 256. Consequently, when a strongest source code (e.g., TCQ) and a strong channel code (e.g., TTCM) are nested together for efficient Costa coding in practice, it is to be understood that two codes are being used with very different effective dimension. It is to be understood that for two lattices to be nested, they do not have to be of the same dimensionality (i.e., a Z-lattice may be nested in any construction-A lattice as the coarse-fine lattice pair). In addition, since turbo TCQ may not perform better than TCQ or has the same effective dimensionality as a good turbo channel code, a form of TCQ or other source code of similar effective dimensionality may be used for the best source coding performance. For instance, in the TCQ/TTCM construction at 1.0 b/s, the 0.406 dB granular gain of TCQ barely exceeds that of a four-dimensional lattice quantizer, but the 7.51 dB packing gain of TTCM may lead to an effective dimension of much higher than 256.

This dimensionality mismatch (i.e., the difference in the effective dimensions of strong source and channel codes) may lead to a fundamental performance tradeoff between the source and channel; codes in any efficient nested design. Due to the coupling between the two component codes, this tradeoff manifests itself in decreased source coding performance as the channel code is made stronger, and vice versa. For instance, with VQ and IRA codes, the nested design leads to strong channel code with subpar source coding performance. In another instance, in migrating from TCQ/TCM to TCQ/TTCM for Costa coding, the performance of TCQ may be severely degraded when TCQ is nested inside the much stronger TTCM code than the similarly structured TCM code. Consequently, a desire in efficient Costa code design is to use the strongest practical source and channel codes and additionally find the best nesting between them in terms of optimizing their performance tradeoff.

Related nested code construction has used TCQ for source coding and TTCM for channel coding. For instance, the trellis structure in the TCQ/TTCM scheme was constructed via a rate-k/n/m concatenated code (denoted by C₁+C₂, with C₁ being the rate-k/n convolutional codes and C₂ the rate-n/m convolutional code) as shown in the encoder block diagram in FIG. 6. Trellis-based constructions are disclosed in “Turbo Coded Trellis-based Constructions for Data Embedding; Channel Coding with Side Information,” J. Chou, S. Pradhan, and K. Ramchandran in Proc. Of 35^{th} Asilomar Conf. Signals, Systems and Computers, Pacific Grove, Calif., November 2001, which is incorporated by reference in its entirety. Channel coding is disclosed in “Channel Coding with Side Information: Theory, Practice and Applications,” J. Chou, Ph.D. dissertation, University of California at Berkeley, Berkeley, Calif., 2002, which is incorporated by reference in its entirety, TCQ relies on the trellis Γ₁ formed by C₁+C₂. The TTCM codes includes a parallel concatenated code with C₂ in both branches. C2 in the bottom branch is preceded by an n-bit symbol interleaver and followed by an m-bit symbol deinterleaver. The two branches are multiplexed by taking even/odd-indexed symbols (of m bits each) from the top/bottom branch before PAM or QAM. It may be seen from FIG. 6 that this code construction may be nested as the TTCM code is part of the overall rate-k/m TCQ source code. At the encoder, every (n-k)-bit segment of the message m is mapped to an n-bit symbol by the pseudo inverse of the parity-check matrix H of C₁ before being added to an output n-bit symbol of C₁. The code words of C1+C2 are shifted by a fixed amount as determined by the message m. Consequently, one coset of TTCM code words is selected by m to be used for TCQ, which uses the Viterbi algorithm to search for its input sequence of k-bit symbols so that αS is quantized to u, and the resulting quantization error X=u−αS satisfies the power constraint E[X²]≦P_{X}. At the decoder, the received signal Y=X+S+Z is first scaled by α, resulting in αY=u+(1−α)(−X)+αZ. Then, the input symbols (of n bits each) to TTCM (i.e., the code words of C₁) are recovered from αY by an iterative BCJR decoder. Finally, the transmitted message m is reconstructed by calculating the syndromes of the recovered code words of C₁. The input sequence of n-bit symbols to the TTCM encoder are denoted as I=[I(0), . . . , I(L−1)], where L is the sequence length (or trellis size) and I(t) is the t-th input symbol (0≦t≦L−1). Whereas, the presence of an interleaver greatly boosts the performance (and the effective dimensionality) of the TTCM code over TCM by reducing the number of nearest neighbors (or the probability of error), the TCQ source code suffers because the interleaver significantly increases the number of paths that need to be searched, making the Viterbi algorithm no longer a viable solution to finding the closest codeword u to αS. Conventionally, the bottom branch of TTCM has been simply ignored during TCQ (i.e., I is only computed from the L symbols passing through the top branch of TTCM during TCQ). But, the actual average quantization error E[X²] includes contributions from both even-indexed symbols from the top branch and odd-indexed symbols from the bottom branch (i.e., L/2 symbols from each of the two branches). When the rate-n/m code C₂ is systematic (for instance, as chosen in simulations), the samples from the top branch may be different than the samples from the bottom in only the m-n parity bits (the n-bit systematic part of each symbol is the same for both branches), which may lead to an extra quantization error in E[X²] that is responsible for the degradation of the source code performance in TCQ/TTCM. For instance, at C*=1.0 b/s, conventional methods have reported a gap of 5.23 dB and 2.07 dB to the capacity in Equation (2) with TCQ/TCM and TCQ/TTCM, respectively. The granular gain g(Λ) of 256-state TCQ in TCQ/TCM is the normal 1.33 dB (hence the Loss_{SC}=0.28 dB of Equation (4)), but it reduces to only 0.406 dB (with Loss_{SC}=1.45 dB) in TCQ/TTCM. Loss_{CC} equals to 4.95 dB and 0.62 dB in TCQ/TCM and TCQ/TTCM, respectively. Such results are included in Table II for comparison purposes. As the rate gets smaller, the power constraint P_{X} (hence the quantization error E[X²]) is smaller, the impact of the extra quantization error on E[X²] becomes more severe. For example, at C*=−/5 b/x, the extra quantization error (even with the minimum m-n=1) causes the granular gain of the source code of the conventional TCQ/TTCM construction to be negative, leading to 4.00 dB loss from the corresponding capacity of Equation (2). Such result is shown in Table III as a benchmark.

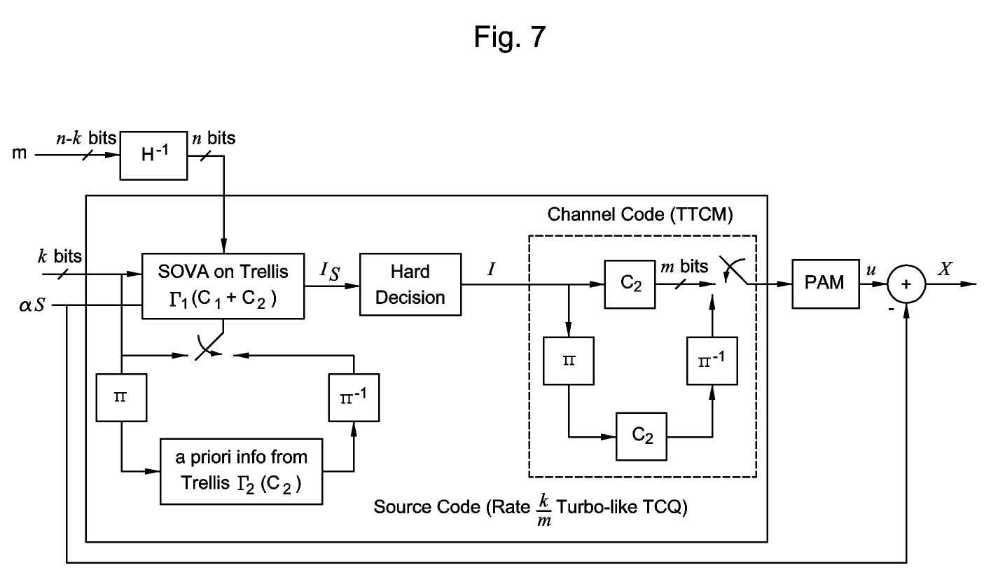

FIG. 7 illustrates an embodiment of a nested turbo code construction. In the embodiment illustrated, the construction includes a turbo-like TCQ instead of a TCQ. The BCJR decoder for TCQ/TTCM of FIG. 6 is used. Without limitation, turbo-like TCQ has been chosen as the source code because it has a similar parallel concatenated structure as used in the TTCM channel code. This structure facilitates the nesting of the source code inside the channel code by enabling both parallel branches of the source code to be taken into account in quantizing αS, hence leading to better source coding performance than in TCQ/TTCM. Without limitation, turbo-like TCQ is better suited than TCQ in fulfilling the need for strong source code in the nested turbo code design. In an embodiment, optimization of the turbo-like TCQ is obtained by choosing the best percentage (i.e., between 50% and 100%) of samples processed by the top branch of the parallel concatenated structure in FIG. 7.

It is to be understood that in the scheme illustrated in FIG. 6 a problem with the source code includes that the bottom branch of TTCM is ignored during TCQ. In the embodiment illustrated in FIG. 7, turbo-like TCQ alleviates such problem by taking into account the bottom branch in source coding. Thus, a difference between the turbo-like TCQ in the embodiment of FIG. 7 and the TCQ of FIG. 6 includes the computation of the input sequences of symbols I=[I(0), . . . , I(L−1)] to the TTCM encoder. For instance, in an embodiment, the soft-output version of I (denoted as I_{S}) is computed using a soft-output Viterbi algorithm (SOVA) for the TCQ in the top branch, which assumes even/odd multiplexing. In the even positions, the TCQ metrics are computed from the top branch alone, while in the odd positions the a priori information from the bottom branch determines the TCQ metrics.

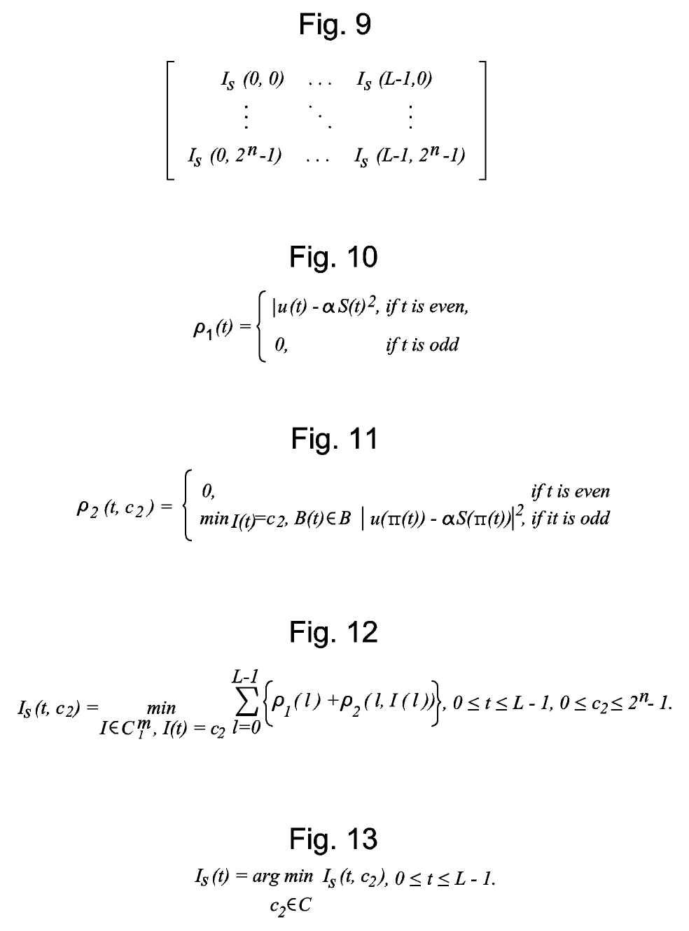

Without limitation, without taking into account the bottom branch, turbo-like TCQ may degenerate to TCQ based on Γ₁. SOVA-based computation of I_{S} may proceed by first setting the n-bit input symbol I(t) to a specific code word c₂ of C₂ (i.e., I(t)=c₂ ε C={0, 1, . . . , 2ⁿ−1}, and then computing the soft-output I_{S}(t, c₂) as the minimal total distortion corresponding to all possible input sequences I ε C₁^{m}, which denotes the coset of C₁ indexed by the message m. I_{S} is shown by the relationship of Equation (6) shown in FIG. 8 where S=[S(0), . . . , S(L−1)] is the length-L sequence of side information, u=[u(0), . . . , u(L−1)] is the sequence of trellis code words corresponding to a certain input sequence I with I(t)=c₂, and p(1) denotes the distortion metric in TCQ. After computing I_{S}(t, c₂) for all t (0≦t≦L−1) and all c₂ ε C, I_{S} takes the matrix form of the matrix shown in FIG. 9.

With turbo-like TCQ, calculation of I_{S} in our nested turbo code design is based on both parallel branches. Trellis Γ₁ for the top TCQ source code is constructed by C₁+C₂, while trellis Γ₂ for the bottom branch contains only C₂. In an embodiment, this parallel concatenated structure is desired for more efficient message transmission (or embedding of the message m in trellis Γ₁), because the message is better protected by the powerful TTCM channel code. In this structure, code C₁ may only be merged on the top branch with C₂, creating the equivalent Γ₁ trellis, but not in the bottom branch in which the interleaver does not allow similar merging.

In an embodiment, SOVA-based computation of I_{S} includes a new composite distortion metric that takes both branches into account. Assuming even-odd multiplexing in the turbo-like TCQ/TTCM encoder, the systematic bits at odd indices in trellis Γ₁ are punctured and the distortion metric p₁(t) is set at index t in trellis Γ₁ to the distortion metric of the Equation (7) of FIG. 10.

The distortion from odd indices is provided by trellis Γ₂ in the form of a priori information. In an embodiment, borrowing ideas from the initialization step in TTCM decoding, for a systematic C₂, this a priori information is computed at index t, denoted as p₂(t, c₂), as the minimal distortion corresponding to the systematic input symbol I(t)=c₂ of C₂ and all possible parity symbols B(t) C B={0, 1, . . . , 2^{m-n}−1}. p₂ is shown in Equation (8) of FIG. 11 where II(t) is the same symbol interleaver as used in the TTCM encoder. The a priori information p₂(t, c₂) is deinterleavered before being fed into trellis Γ₁. To incorporate both p₁(t) and p₂(t,c₂) into the computation of I_{S}(t,c₂), p(t)=p₁(t)+p₂(t,I(t)) is set in Equation (t) to provide Equation (9) as shown in FIG. 12. The de-interleaving for the Equation (9) was provided in Equation (8). After running the SOVA with Equation (10) on trellis Γ₁, I_{S} was output before hard thresholding I_{S} to I with Equation (10) as shown in FIG. 13.

Without limitation, turbo-like TCQ is motivated by the need to take into account distortion from quantizers in both parallel branches of the embodiment of FIG. 7. It is not turbo TCQ mainly because quantization is not done iteratively (so as to avoid performance degradation). Without iterative quantization (or source encoding), the distortion form the bottom-branch TCQ may only be included in the form of a priori information as accomplished in Equation (8). This may limit the improvement of turbo-like TCQ/TTCM over TCQ/TTCM in terms of source coding performance. The effective dimensionality of the turbo-like TCQ source code may be mush lower than that of the TTCM channel code.

Without limitation, it is to be understood that turbo-like TCQ is so referred because it has the parallel concatenated structure with interleavers II and II⁻¹, and the operation in Equation (9) implements the first iteration of turbo TCQ, which takes advantage that turbo TCQ may improve upon TCQ at the first iteration before losing ground at subsequent locations.

In an embodiment, in regards to a performance trade-off between turbo-like TCQ and TTCM, T is the percentage of samples chosen by the multiplexer from the top branch of the parallel concatenated structure (for both turbo-like TCQ and TTCM). With the default setting of even-odd multiplexing in FIG. 7, T=50%. But T may be varied from 50% to 100%. The distortion metric p₁(t) in Equation (7) and the a priori information p2(t, c2) in Equation (8) may be modified when T≠50%. As T is increased from 50% to 100%, the turbo effect due to the presence of the interleaver may be gradually reduced, causing the performance of the TTCM code to deteriorate. When T=100%, TTCM degrades to TCM, which may lead to the worst channel coding performance. Increasing T may provide improved source coding performance in our nested turbo code design, which may be because the a priori information p₂(t, c₂) accounted in turbo-like TCQ for samples form the bottom branch may not be as reliable as the actual distortion contributed by these samples to the final average quantization error E[X²]. Higher T means less samples from the bottom branch, and maybe less unreliable information in the distortion metric of turbo-like TCQ. When T=100%, turbo-like TCQ degenerates to TCQ, providing the best source coding performance, in which the turbo-like TCQ/TTCM code becomes a TCQ/TCM code.

Consequently, with the inclusion of p₂(t, c₂), the extra quantization error also exists in turbo-like TCQ, although it may be smaller than that in TCQ/TTCM. Increasing T reduces the number of samples contributing to this extra quantization error, making it even smaller. By increasing T form 50% to 100%, the TTCM channel code is made weaker, but the turbo-like TCQ source code is stronger. The parameter T offers a means of trading off the performance of the source code and that of the channel code in the nested design. In an embodiment, the best performance tradeoff may be reached by searching for the optimal percentage T* between 50% and 100% that gives the minimal gap from the capacity-achieving SNR.

Without limitation, because the above performance tradeoff is rooted in dimensionality mismatch between the source and channel coding components in any nested design for Costa coding, it also applies to the TCQ/TTCM code construction, which means that conventional means results of the embodiments of FIG. 6 with TCQ/TTCM and T=50% may be improved by searching for the best T* between 50% and 100%. With T=100%, the TCQ/TTCM code also becomes the simple TCQ/TCM code. With T=50% (or default odd-even multiplexing, because turbo-like TCQ provides better source coding performance in the nested turbo code design that the TCQ/TTCM code construction (meaning dimensionality mismatch is less severe), it may be expected that the optimal T* is less than that for the TCQ/TTCM construction. If there were turbo TCQ (with the same effective dimensionality as TTCM), the optimal T* may be 50% in an ideal nested turbo code design (i.e., no performance tradeoff may be needed).

To further illustrate various illustrative embodiments of the present invention, the following examples are provided.

### EXAMPLE 1

Picking the appropriate code rate parameters (n, k, m), it was simulated the code design for transmission rates of 2.0, 1.0, and 0.5 b/s. For such transmission rates, both convolutional codes C₁ and C₂ were chosen as the constraint-length four Ungerboeck code. C2 was systematic to fit th turbo algorithm. If C1 was also systematic, there would be an error propagation when recovering the original message m via computing the syndromes, since the parity-check polynomials may have infinite weights. Therefore, non-systematic C1 was chosen.

The code C2 was mapped to a finite constellation, which was called the based constellation. The side information S had an arbitrary large magnitude, and therefore was replicated the basic constellation infinitely so that S never lied in the overload region of the quantizer (so as to satisfy the power constraint). The quantizer thus selected a copy of the basic constellation code word that lay nearest to S.

The Costa codes' performance was evaluated by its BER at a certain SNR. It was first looked at into the effect of varying the uniform quantization stepsize q in TCQ. The experiments Indicated little performance difference by using different q's, and it was true for different JT's and transmission rates. Thus, for results reporting the following, q is set to 1.0 for all transmission rates. In addition, all results were base on 256-state TCQ and a BER of 10⁻⁵.

Simulation results at 2.0 b/s

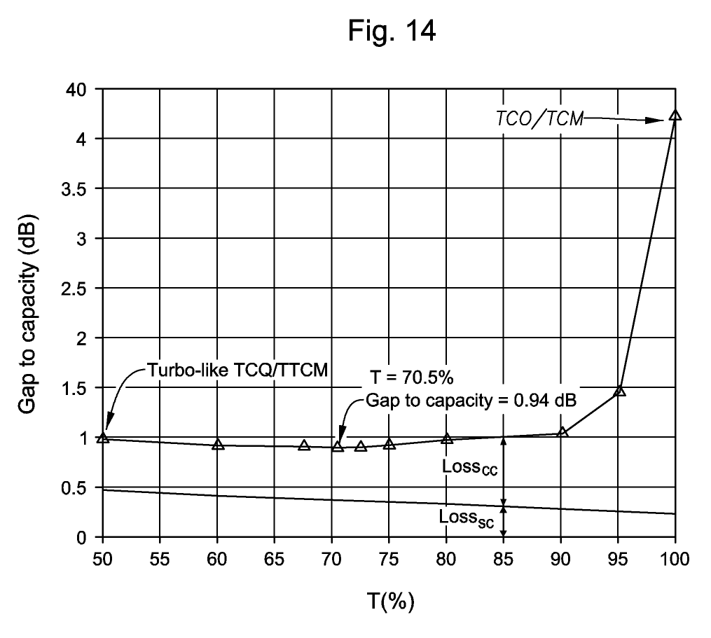

FIG. 14 illustrates the performance gap (in dB) of the turbo-like TCQ/TCM code to the capacity-achieving SNR vs. the percentage T when the trellis (or interleaver) length is L=50,000. FIG. 14 and Table I show that the nested turbo-like code outperforms the TCA/TTCM code.

Simulation results at 1.0 b/s

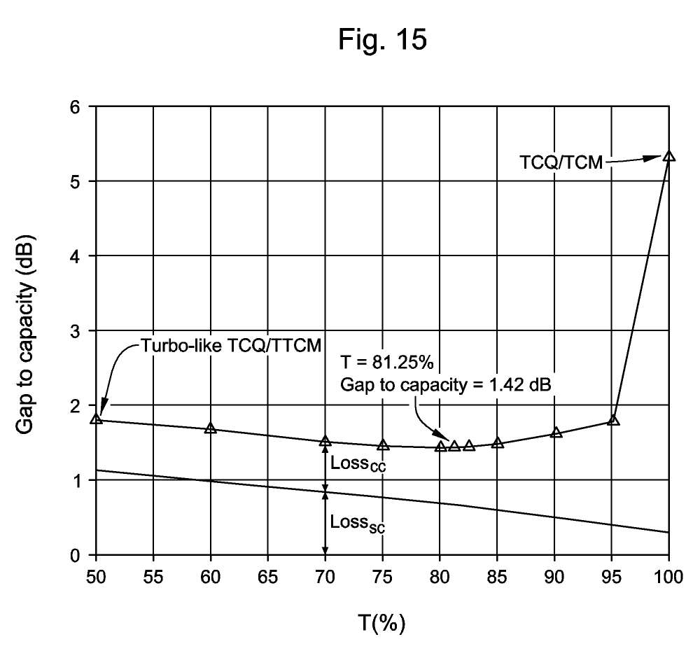

FIG. 15 illustrates the performance gap (in dB) of the turbo-like TCQ/TCM code to the capacity-achieving SNR vs. the percentage T when the trellis (or interleaver) length is L=50,000. Table II with C*=1.0 b/s is the counterpart of Table I with C*=2.0 b/s. Table II shows that optimizing T is more effective at lower rates.

Simulation results at 0.5 b/s

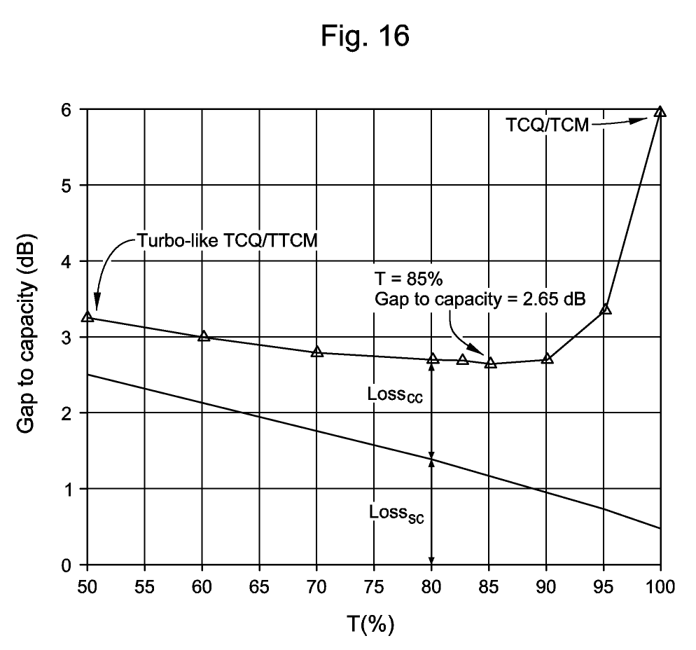

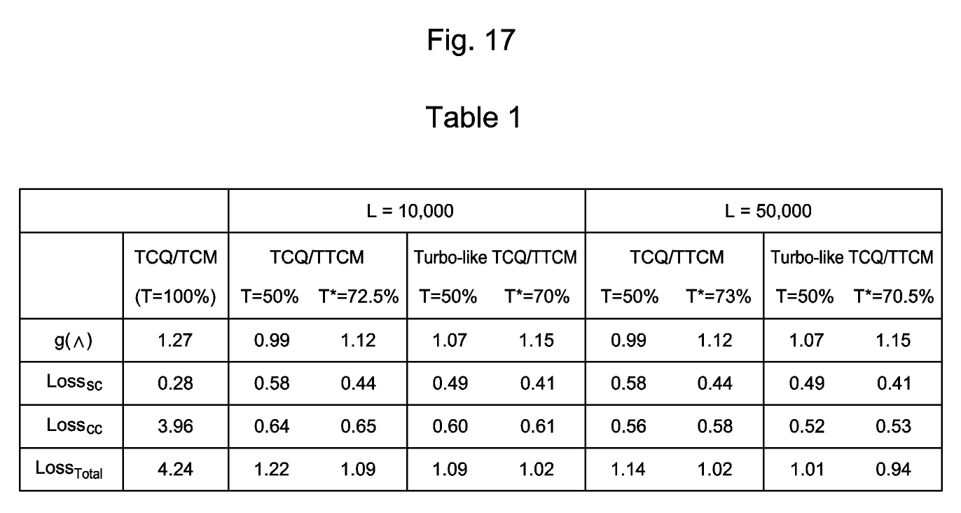

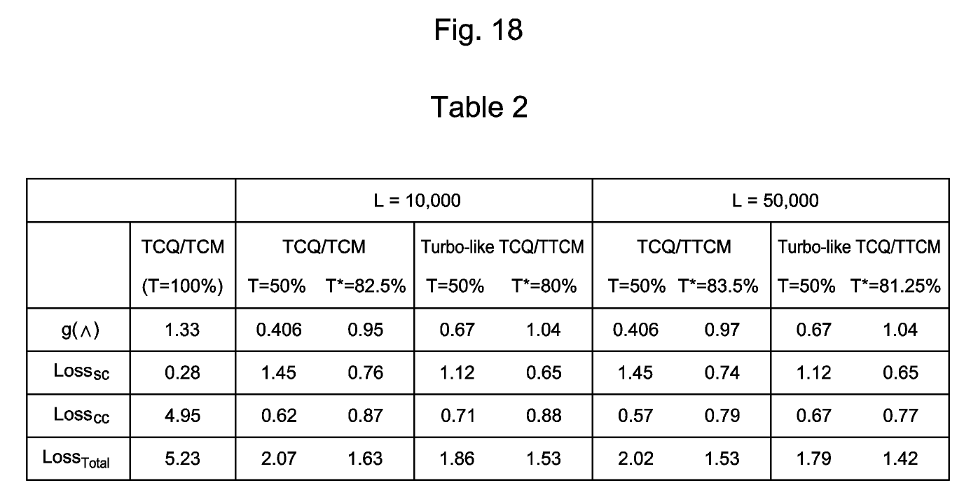

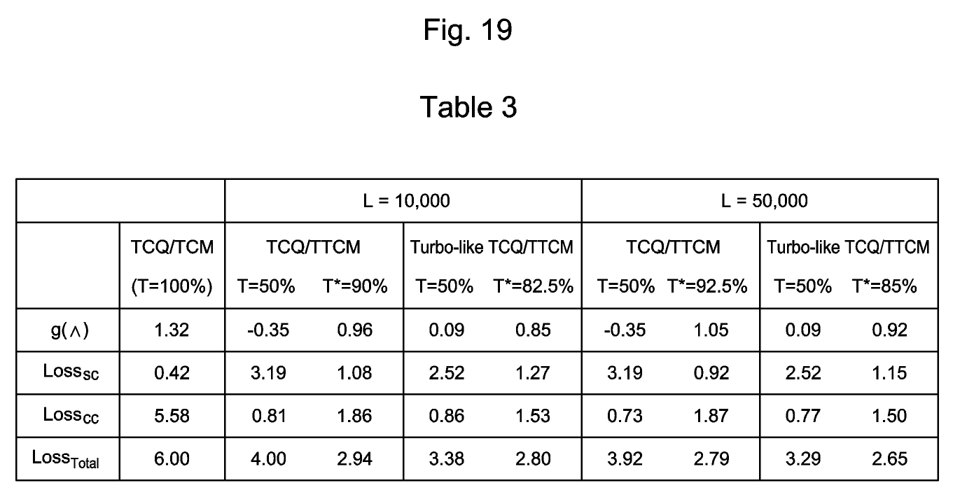

FIG. 16 shows the performance gap (in dB) of the turbo-like TCQ/TCM code to the capacity-achieving SNR vs. the percentage T when the trellis (or interleaver) length is L=50,000. From Table III, it may be seen that compared to using T=50%, the performance gain from using the optimal T* was more than 0.5 dB.

Although the present invention and its advantages have been described in detail, it should be understood that various changes, substitutions and alterations may be made herein without departing from the spirit and scope of the invention as defined by the appended claims.

1. A method of providing a design for Costa coding for transmitting messages, comprising in a nested setup of:
(A) providing a turbo-like trellis-coded quantization for source coding; and
(B) providing a turbo trellis-coded modulation for channel coding.

2. An encoder system for Costa code design for a message m transmission, wherein the message m comprises m-bits, comprising:
side information S, wherein channel codewords are grouped in bins that correspond to same messages m and within each bin a codeword is selected according to the side information S;
a turbo-like source code comprising computation of input sequences of symbols I, wherein the computation comprises a soft-output Viterbi algorithm for computing a soft-output version of I comprising I_{S}, wherein the source code comprises a top source code branch and a bottom source code branch, and wherein the top source code branch and the bottom source code branch are parallel, and wherein the top source code branch comprises trellis Γ₁ constructed of C₁+C₂ and the bottom source code branch comprises trellis Γ₂ constructed by C₂, wherein C₁ comprises rate-k/n convolutional code and C₂ comprises rate-n/m convolutional code;
a channel code comprising a parallel concatenated code with C₂ in both branches; and
wherein the source code is nested inside the channel code.

3. The encoder system of claim 2, wherein the side information S is linearly scaled by α and quantized to a codeword u by the source code selected by the message m.

4. The encoder system of claim 3, wherein a is determined by:
α=P_{X}/(P_{X}+P_{Z})
wherein P_{X} is channel input power constraint and P_{Z} is noise power.

5. The encoder system of claim 2, wherein every (n-k)-bit segment of the message m is mapped to an n-bit symbol by a pseudo inverse parity-check matrix H of C₁.

6. The encoder system of claim 2, wherein I is determined by:
I=[I(0), . . . , I(L−1)]
wherein L is a sequence length.

7. The encoder system of claim 6, wherein the soft-output Viterbi algorithm is for the trellis Γ₁.

8. The encoder system of claim 6, further comprising even/odd multiplexing comprising even positions and odd positions.

9. The encoder system of claim 8, wherein in the even positions trellis Γ₁ is computed from the top source code branch.

10. The encoder system of claim 8, wherein a distortion metric p₁(t) is set at index t in trellis Γ₁ to
$${ρ}_{1} ( t ) = \{ \begin{matrix}\vert μ ( t ) - α S ( t ) {\vert}^{2} \\ 0 , \end{matrix}$$
wherein the distortion metric is set to |μ(t)−αS(t)|² when t is even and set to 0 when t is odd, and wherein t is an index of L codeword.

11. The encoder system of claim 10, wherein distortion from the odd positions is provided by trellis Γ₂ in a priori information form.

12. The encoder system of claim 11, wherein the a priori information is computed at index t denoted as p₂(t, c₂) by
$${ρ}_{2} ( t , {c}_{2} ) = \{ \begin{matrix}0 , \\ {min}_{I ( t ) = {c}_{2} , B ( t ) ∈ B \vert u ( Π ( t ) ) - α S ( Π ( t ) ) {\vert}^{2} }\end{matrix}$$
wherein the a priori information is 0 when t is even and min_{I(t)} when t is odd, wherein B(t) is
B(t)εB={0, 1, . . . , 2^{m-n}−1}
wherein m is m-bits and n is n-bits, [μ(0), . . . , μ(L−1)] is a sequence of trellis codewords corresponding to a certain input sequence I with I(t)=C₂, Π(t) is an interleaver, μ(Π(t)) is an interleaved version of μ(t) for t=0, . . . , L−1, and αS is side information S linearly scaled by α.

13. The encoder system of claim 12, wherein p(t)=p₁(t)+p₂(t, I(t)), and wherein I_{S} is computed as I_{S}(t, C₂) by
$${I}_{S} ( t , {c}_{2} ) = {min}_{I ∈ {C}_{I}^{m} , I ( t ) = {c}_{2}} {\sum }_{l = 0}^{L - 1} \{ {ρ}_{1} ( l ) + {ρ}_{2} ( l , I ( l ) ) \} , \\ 0 \leq t \leq L - 1 , 0 \leq {c}_{2} \leq {2}^{n} - 1$$
wherein l indices the sequence length.

14. The encoder system of claim 13, wherein I_{S} is output before hard thresholding I_{S} to I by
$${I}_{S} ( t ) = arg {min}_{{c}_{2} ∈ C} {I}_{S} ( t , {c}_{2} )$$
wherein 0≦t≦L−1.

15. The encoder system of claim 11, wherein the a priori information is fed into trellis Γ₁.

16. The encoder system of claim 15, wherein the a priori information is deinterleaved before being fed into trellis Γ₁.

17. The encoder system of claim 2, wherein C₂ in the bottom branch is preceded by an interleaver.

18. The encoder system of claim 2, wherein C₂ in the bottom branch is followed by a deinterleaver.

19. The encoder system of claim 2, wherein the channel code is turbo trellis-coded modulation.

20. The encoder system of claim 19, wherein the turbo-trellis-coded modulation comprises a parallel concatenated code with C₂ in both branches.
